(19) United States
(12) Patent Application Publication
(10) Pub. No.: US 2024/0166079 A1
(43) Pub. Date: May 23, 2024

(54) SERVER AND GUIDANCE METHOD

(71) Applicant: TOYOTA JIDOSHA KABUSHIKI KAISHA, Toyota-shi (JP)

(72) Inventors: Mitsuaki TOMITA, Toyota-shi (JP); Kenji TAHARA, Toyota-shi (JP); Hiroshi ASHIDA, Nukata-gun (JP); Takenori SHIMIZU, Inuyama-shi (JP); Tamaki OZAWA, Toyota-shi (JP); Tetsuro KUNIYOSHI, Nagoya-shi (JP)

(73) Assignee: TOYOTA JIDOSHA KABUSHIKI KAISHA, Toyota-shi (JP)

(21) Appl. No.: 18/376,518

(22) Filed: Oct. 4, 2023

(30) Foreign Application Priority Data
Nov. 21, 2022 (JP) 2022-185994

(51) Int. Cl. B60L 53/68; B60L 53/62; B60L 53/66; G06Q 10/02; G06Q 50/06

(52) U.S. Cl. CPC B60L 53/68; B60L 53/62; B60L 53/66; G06Q 10/02; G06Q 50/06

(57) ABSTRACT

A server includes a control unit configured to extract, among facilities different from a power controller configured to execute power control including at least one of charging and discharging of an electrified vehicle, the facility that is available, during a reservation period for use of the power controller, to a user who uses the power controller during the reservation period and a communication unit configured to transmit information on the extracted facility to at least one of the electrified vehicle and an information device that are associated with the user.

### CROSS-REFERENCE TO RELATED APPLICATION

This application claims priority to Japanese Patent Application No. 2022-185994 filed on Nov. 21, 2022 incorporated herein by reference in its entirety.

### BACKGROUND

### 1. Technical Field

The present disclosure relates to a server and a guidance method. (US) The present disclosure relates to a server, a guidance method, and a notification device. (CN)

### 2. Description of Related Art

WO2013/137071 discloses a system that charges an electrified vehicle based on a reservation for use of a charger.

### SUMMARY

A user of an electrified vehicle may want to make good use of the charging period of the electrified vehicle. Therefore, there is a demand for a system that can achieve easy use of facilities such as a restaurant while the charger (power controller) is in use.

The present disclosure has been made to solve the above challenge, and it is an object thereof to provide a server, a guidance method, and a notification device that can achieve easy use of a predetermined facility while a power controller is in use.

A server according to a first aspect of the present disclosure includes a control unit configured to extract, among facilities different from a power controller configured to execute power control including at least one of charging and discharging of an electrified vehicle, the facility that is available, during a reservation period for use of the power controller, to a user who uses the power controller during the reservation period, and a communication unit configured to transmit information on the extracted facility to at least one of the electrified vehicle and an information device that are associated with the user.

As described above, the server according to the first aspect of the present disclosure extracts the facility that is available during the reservation period for the use of the power controller, and notifies the user about the information on the extracted facility. Therefore, the user can acquire the information on the facility that is available during the reservation period for the power controller. As a result, the user can easily use the facility while the power controller is in use. Thus, the user can make good use of time at the facility during the execution of the power control.

In the server according to the first aspect, the control unit may be configured to extract the facility that is reservable within the reservation period. With this configuration, the user can acquire the information on the facility that is reservable within the reservation period for the power controller.

In the server according to the first aspect, the control unit may be configured to extract the facility that is available during the reservation period based on a predicted value of a stay period at the facility. With this configuration, the facility that is available during the reservation period for the power controller can be extracted more accurately based on the predicted value of the stay period at the facility.

In the server according to the first aspect, the control unit may be configured to extract the facility that is available during the reservation period based on a waiting period for use of the facility. With this configuration, the facility that is available during the reservation period for the power controller can be extracted more accurately based on the waiting period for use of the facility.

In the server according to the first aspect, the control unit may be configured to extract the facility that is available during the reservation period based on a movement period required to move from the power controller to the facility. With this configuration, the facility that is available during the reservation period for the power controller can be extracted more accurately based on the movement period required to move to the facility.

In the server according to the first aspect, the control unit may be configured to extract the facility that is available during the reservation period based on a total value of a predicted value of a stay period at the facility, a waiting period for use of the facility, and a movement period required to move from the power controller to the facility. With this configuration, the facility that is available during the reservation period for the power controller can be extracted even more accurately based on the predicted value of the stay period at the facility, the waiting period for use of the facility, and the movement period required to move to the facility.

In the server according to the first aspect, the control unit may be configured to extract the facility that is available during the reservation period based on a type of the facility that the user desires to use during the reservation period. With this configuration, the user can use the desired facility during the reservation period. As a result, the user can make better use of time during the reservation period.

In the server according to the first aspect, the control unit may be configured to extract the facility located within a predetermined range that is based on a position of a reserved power controller. With this configuration, the facilities outside the predetermined range are excluded from the extraction targets. Therefore, it is possible to reduce the processing load on the control unit and complete the extraction process more quickly as compared with a case where the facilities outside the predetermined range are also included in the extraction targets.

In the server according to the first aspect, the control unit may be configured to adjust an incentive to be given to the user depending on a crowding level of the facility that the user determines to use during the reservation period. With this configuration, the user can select a facility with a larger incentive. As a result, it is possible to easily adjust the crowding level of the facility.

In the server according to the first aspect, the control unit may be configured to predict a time when the user leaves the facility based on the predicted value of the stay period, calculate an execution condition of the power control for causing the electrified vehicle to have a state of charge (SOC) based on full charge at the leaving time associated with the facility that the user determines to use, and control the electrified vehicle to execute the power control in accordance with the execution condition. With this configuration, overcharging of the electrified vehicle can be suppressed. As a result, deterioration of a battery of the electrified vehicle can be suppressed. The SOC based on full charge includes an SOC of 100% and an SOC close to 100%.

A facility guidance method according to a second aspect of the present disclosure includes a step of extracting, among facilities different from a power controller configured to execute power control including at least one of charging and discharging of an electrified vehicle, the facility that is available, during a reservation period for use of the power controller, to a user who uses the power controller during the reservation period, and a step of transmitting information on the extracted facility to at least one of the electrified vehicle and an information device that are associated with the user.

As described above, in the facility guidance method according to the second aspect of the present disclosure, the facility that is available during the reservation period for the use of the power controller is extracted, and the user is notified about the information on the extracted facility. Thus, it is possible to provide the facility guidance method with which the facility can easily be used while the power controller is in use.

A server according to a third aspect of the present disclosure includes a control unit configured to extract, among power controllers each configured to execute power control including at least one of charging and discharging of an electrified vehicle, the power controller that is available, during an expected use period for use of a facility different from the power controllers, to a user who uses the facility during the expected use period, and a communication unit configured to transmit information on the extracted power controller to at least one of the electrified vehicle and an information device that are associated with the user.

As described above, the server according to the third aspect of the present disclosure extracts the power controller that is available during the expected use period for the use of the facility, and notifies the user about the information on the extracted power controller. Therefore, the user can acquire the information on the power controller that is available during the expected use period for the facility. As a result, the user can easily use the power controller while using the predetermined facility.

A notification device according to a fourth aspect of the present disclosure is configured to give a notification about, among facilities different from a power controller configured to execute power control including at least one of charging and discharging of an electrified vehicle, the facility that is available, during a reservation period for use of the power controller, to a user who uses the power controller during the reservation period.

As described above, the notification device according to the fourth aspect of the present disclosure notifies the user about the information on the facility that is available during the reservation period for the use of the power controller. Thus, it is possible to provide the notification device with which the facility can easily be used while the power controller is in use.

According to the present disclosure, the user can easily use the predetermined facility while the power controller is in use.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows the configuration of a system according to a first embodiment;

FIG. 2 shows sequence control of the system according to the first embodiment;

FIG. 3 shows an example of an initial screen of an electric vehicle supply equipment (EVSE) reservation screen according to the first embodiment;

FIG. 4 shows the EVSE reservation screen after extraction of facilities according to the first embodiment;

FIG. 5 illustrates a method for extracting a reservable facility according to the first embodiment;

FIG. 6 illustrates a method for extracting a non-reservable facility according to the first embodiment;

FIG. 7 shows a relationship between an SOC of an electrified vehicle and time;

FIG. 8 shows the configuration of a system according to a second embodiment;

FIG. 9 shows sequence control of the system according to the second embodiment;

FIG. 10 shows an example of an initial screen of an EVSE reservation screen according to the second embodiment;

FIG. 11 shows the EVSE reservation screen after extraction of EVSE units according to the second embodiment;

FIG. 12 illustrates a method for extracting an EVSE unit when using a reservable facility according to the second embodiment; and

FIG. 13 illustrates a method for extracting an EVSE unit when using a non-reservable facility according to the second embodiment.

### DETAILED DESCRIPTION OF EMBODIMENTS

### First Embodiment

Hereinafter, a first embodiment of the present disclosure will be described in detail with reference to the drawings. The same or corresponding parts are denoted by the same signs throughout the drawings, and description thereof will not be repeated.

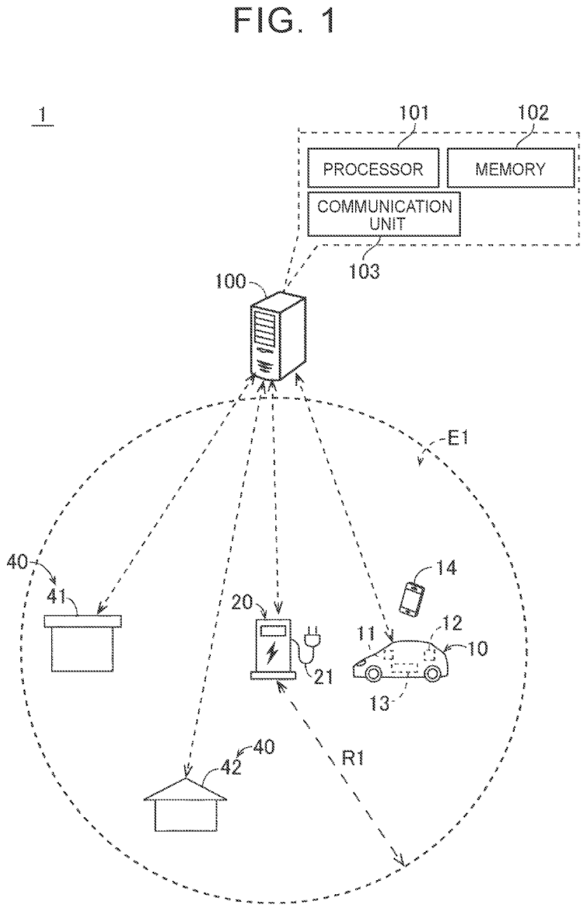

FIG. 1 shows the configuration of a system 1 according to the first embodiment. The system 1 includes a server 100, an electrified vehicle 10, a plurality of electric vehicle supply equipment (EVSE) units 20, and facilities 40. The system 1 may include one EVSE unit 20 alone. In the example shown in FIG. 1, one EVSE unit 20 is shown alone for simplification. The EVSE unit 20 is an example of a “power controller” according to the present disclosure.

Examples of the electrified vehicle 10 include a plug-in hybrid electric vehicle (PHEV), a battery electric vehicle (BEV), and a fuel cell electric vehicle (FCEV).

The electrified vehicle 10 includes a navigation system 11 and a communication device 12. The electrified vehicle 10 further includes a battery 13 that supplies electric power to electric devices such as the navigation system 11 and the communication device 12. The communication device 12 may include a data communication module (DCM) or may include a communication interface (UF) compatible with the fifth generation mobile communication system (5G). The navigation system 11 is an example of a “notification device” according to the present disclosure. The electrified vehicle 10 is electrically connectable to the EVSE unit 20.

The battery 13 of the electrified vehicle 10 is charged by connecting a charging cable 21 connected to the EVSE unit 20 to an inlet of the electrified vehicle 10. Charging of the battery 13 with the EVSE unit 20 is an example of “power control” according to the present disclosure.

The server 100 manages charging reservations for the electrified vehicle 10 (and other electrified vehicles) with the EVSE units 20.

The server 100 manages information on a plurality of registered electrified vehicles 10 (hereinafter also referred to as “vehicle information”), information on each registered user (hereinafter also referred to as “user information”), and information on a plurality of registered EVSE units 20 (hereinafter also referred to as “EVSE information”). The user information, the vehicle information, and the EVSE information are distinguished by identification information (IDs) and stored in a memory 102 described later.

A user ID is identification information for identifying a user, and also serves as information for identifying a mobile terminal 14 carried by the user (terminal ID). The server 100 distinguishes and saves information received from the mobile terminal 14 by the user ID. The user information includes a communication address of the mobile terminal 14 carried by the user, and a vehicle ID of the electrified vehicle 10 belonging to the user. The mobile terminal 14 is an example of an “information device” according to the present disclosure.

The vehicle ID is identification information for identifying the electrified vehicle 10. The vehicle ID may be a license plate number or may be a vehicle identification number (VIN). The vehicle information includes an operation schedule of each electrified vehicle 10.

An EVSE-ID is identification information for identifying the EVSE unit 20. The EVSE information includes a communication address of each EVSE unit 20 and the state of the electrified vehicle 10 connected to the EVSE unit 20. The EVSE information also includes information indicating a combination of the electrified vehicle 10 and the EVSE unit 20 connected to each other (e.g., a combination of the EVSE-ID and the vehicle ID).

The server 100 includes a processor 101, the memory 102, and a communication unit 103. The processor 101 is an example of a “control unit” according to the present disclosure.

The memory 102 stores, in addition to programs to be executed by the processor 101, information to be used in the programs (e.g., maps, mathematical formulas, and various parameters).

The memory 102 stores information on expected periods at the facilities 40. Examples of the facilities 40 include a cafe 41 and a restaurant 42. The facilities 40 may include a store for shopping. The memory 102 stores, for example, information indicating that the expected periods at the cafe 41 and the restaurant 42 are 30 minutes and 60 minutes, respectively. For example, the memory 102 may store an average of periods spent by customers at each facility 40 as the expected period associated with the facility 40.

The memory 102 stores position information of each EVSE unit 20 and position information of each facility 40.

The communication unit 103 includes various communication I/Fs. The processor 101 controls the communication unit 103. Specifically, the processor 101 communicates with the communication device 12 of the electrified vehicle 10 (or the mobile terminal 14), the EVSE units 20, and the facilities 40 (41, 42) via the communication unit 103.

The user of the electrified vehicle 10 may want to make good use of the charging period of the electrified vehicle 10. One possible way is to have a meal at the facility 40 around the EVSE unit 20 during charging of the electrified vehicle 10. When the facility 40 is crowded, it is difficult for the user to have a meal during the charging. Therefore, there is a demand to improve the convenience of the user at the facility 40 by providing a system in which the user can easily use the facility 40 during the charging of the electrified vehicle 10.

In the first embodiment, the processor 101 extracts a facility 40 that is available, during a reservation period for the use of the EVSE unit 20, to the user who uses the EVSE unit 20 during the reservation period. The communication unit 103 transmits information on the extracted facility 40 to the electrified vehicle 10 associated with the user. The communication unit 103 may transmit the information to the mobile terminal 14 or to both the mobile terminal 14 and the electrified vehicle 10. When the information is transmitted to the mobile terminal 14, the mobile terminal 14 is an example of the “notification device” according to the present disclosure.

Facility Guidance Method

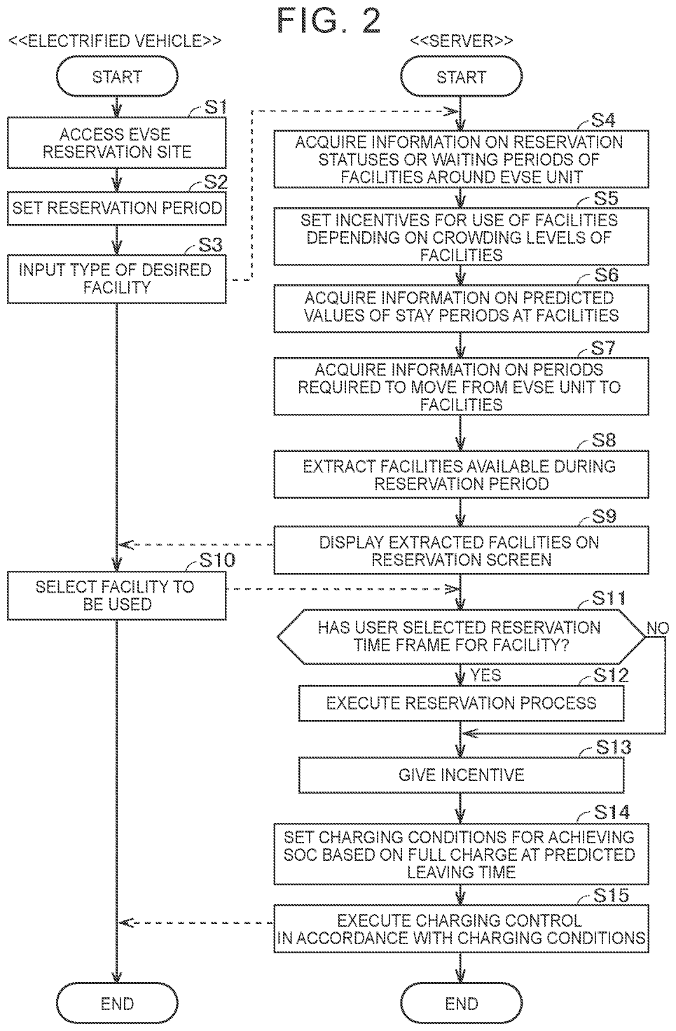

Referring to a sequence diagram of FIG. 2, description will be given of a method for giving guidance on the facility 40 to be used by the user during the reservation period for the EVSE unit 20.

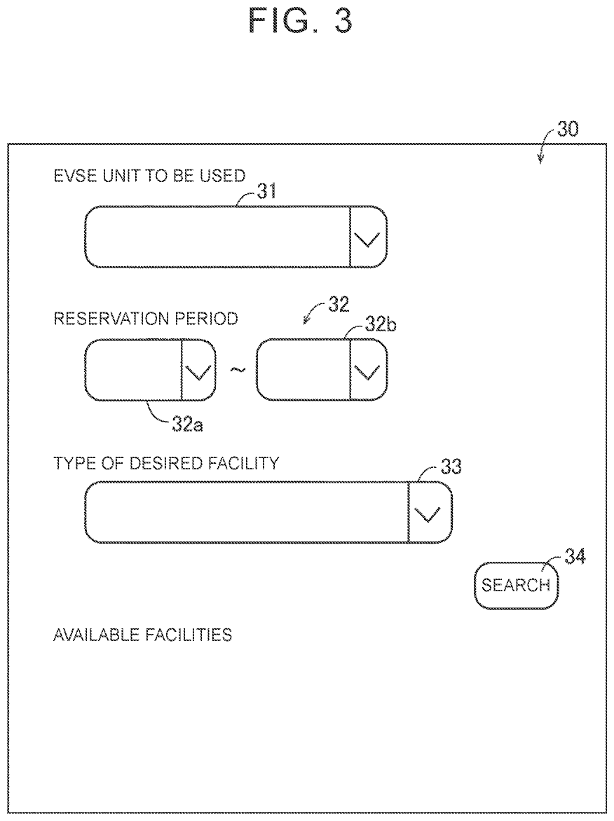

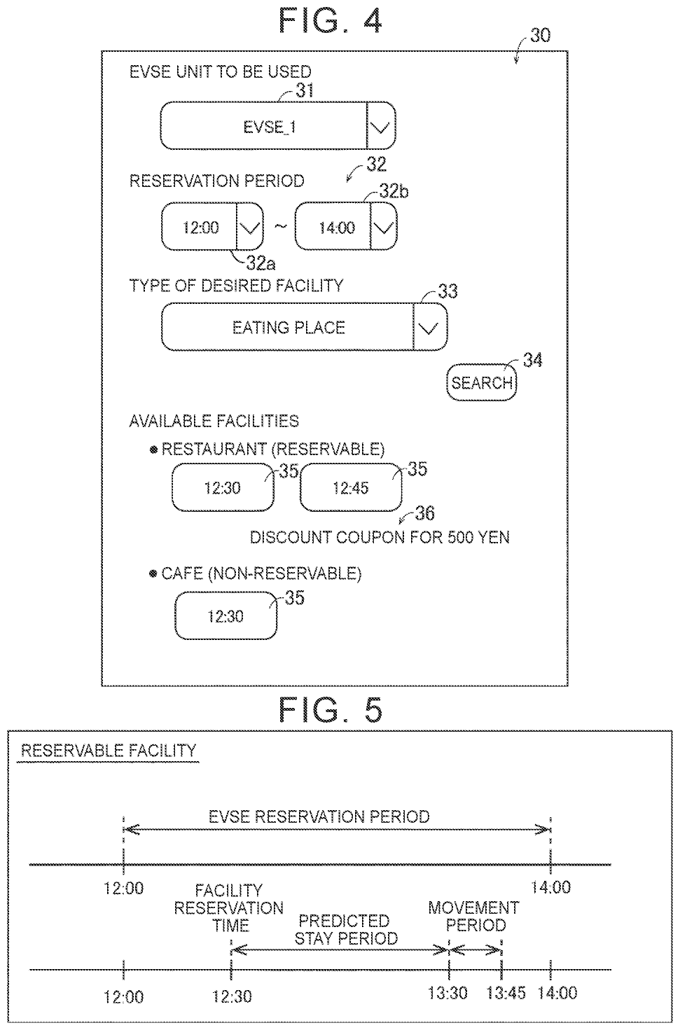

In step S1, the user of the electrified vehicle 10 accesses, through the navigation system 11, a reservation site for making a reservation to use the EVSE unit 20. A reservation screen 30 (see FIG. 3) for the EVSE unit 20 is displayed on the navigation system 11. The reservation site may be accessed through the mobile terminal 14, and the reservation screen 30 may be displayed on the mobile terminal 14. The configuration of the reservation screen 30 is not limited to the examples of FIG. 3 and FIG. 4 described later.

In step S2, the user of the electrified vehicle 10 inputs information on the EVSE unit 20 to be used (EVSE-ID etc.) in an input field 31 of the reservation screen 30. Examples of the input field 31 include a pull-down input field. The user inputs an expected reservation period for charging of the battery 13 (reservation period for the EVSE unit 20) in an input field 32 of the reservation screen 30. The input field 32 includes a field 32a for inputting a start time of the reservation period and a field 32b for inputting an end time of the reservation period. Examples of the fields 32a and 32b include a pull-down input field configured such that time can be selected with intervals of 15 minutes. The EVSE unit 20 in the following description refers to the EVSE unit 20 input by the user in the input field 31.

In step S3, the user inputs a type of facility desired by the user in an input field 33 (see FIG. 3) of the reservation screen 30. Examples of the type of facility include eating places, shops, movie theaters, convenience stores, and restrooms. Examples of the input field 33 include a pull-down input field. When a button 34 of the reservation screen 30 is selected, processes of step S4 and subsequent steps are started.

In step S4, the processor 101 acquires information on reservation statuses or waiting periods associated with facilities 40 of the type specified by the user in step S3 among the facilities 40 located within a predetermined range E1 (see FIG. 1) that is based on the position of the EVSE unit 20 specified in step S2. Thus, the processor 101 acquires information on crowding levels of the facilities 40 within the predetermined range E1. Examples of the predetermined range E1 include an area with a radius R1 (e.g., 500 m) about the EVSE unit 20. The facilities 40 in the following description refer to the facilities 40 that are located within the predetermined range E1 and are of the type specified by the user in step S3. One facility 40 may be provided alone in the predetermined range E1.

Specifically, the processor 101 receives information on the reservation statuses or the waiting periods of the facilities 40 from the facilities 40 through the communication unit 103. The processor 101 may estimate the reservation statuses or the waiting periods of the facilities 40 based on the information on the crowding levels transmitted from the facilities 40 (e.g., information on the numbers of vehicles and people in the facilities 40).

In step S5, the processor 101 sets incentives for the use of the facilities 40. The processor 101 sets (adjusts) the incentives depending on the crowding levels of the facilities 40 based on the information acquired in step S4. Examples of the incentives include a discount on the usage fee of the facility 40 and a coupon available at the facility 40. The processor 101 increases the incentive for a facility 40 having a lower crowding level.

In step S6, the processor 101 acquires information on predicted values of stay periods at the facilities 40. As described above, the predicted values of the stay periods associated with the facilities 40 are stored in the memory 102. Specifically, the processor 101 acquires, from the memory 102, information indicating that the predicted value of the stay period at the restaurant 42 is 60 minutes. The processor 101 acquires, from the memory 102, information indicating that the predicted value of the stay period at the cafe 41 is 30 minutes.

The processor 101 may correct the predicted values of the stay periods stored in the memory 102 based on the crowding levels of the facilities 40. Specifically, the processor 101 may execute correction so that the predicted value increases as the crowding level of the facility 40 increases.

In step S7, the processor 101 acquires (calculates) information on periods required to move from the EVSE unit 20 to the facilities 40. Specifically, the processor 101 calculates distances between the EVSE unit 20 and the facilities 40 by using the position information of the EVSE unit 20 and the position information of the facilities 40 that are stored in the memory 102. The processor 101 calculates the periods required to move from the EVSE unit 20 to the facilities 40 based on the calculated distances.

The processor 101 may correct the movement periods required to move from the EVSE unit 20 to the facilities 40 based on the user of the electrified vehicle 10. For example, the processor 101 may execute correction so that the movement period increases when users include a child or an elderly person. The processor 101 may correct the movement periods based on information on the way of user's movement (walking, taxi, etc.).

In step S8, the processor 101 extracts facilities 40 available during the reservation period for the EVSE unit 20 within the predetermined range E1 based on the pieces of information associated with steps S3, S4, S6, and S7.

FIG. 5 shows an example in which a reservable facility 40 (e.g., the restaurant 42) is extracted. The processor 101 extracts a facility 40 reservable within the reservation period for the EVSE unit 20 (12:00 to 14:00 in FIG. 5). Specifically, the processor 101 extracts a facility 40 in which a period from a reservation time for the facility 40 (12:30 in FIG. 5) to a time when the user returns to the EVSE unit 20 (13:45 in FIG. 5) is within the reservation period.

The processor 101 predicts a time when the user will leave the facility 40 (13:30 in FIG. 5) based on the reservation time for the facility 40 and the predicted stay period associated with step S6 (one hour in FIG. 5). The processor 101 predicts a time when the user will return to the EVSE unit 20 based on the movement period associated with step S7 (15 minutes in FIG. 5) and the predicted leaving time. That is, the processor 101 executes the extraction based on the total value of the predicted value of the stay period and the movement period. If a waiting period is predicted despite the reservable facility 40, the extraction may be executed by adding the waiting period to the total value.

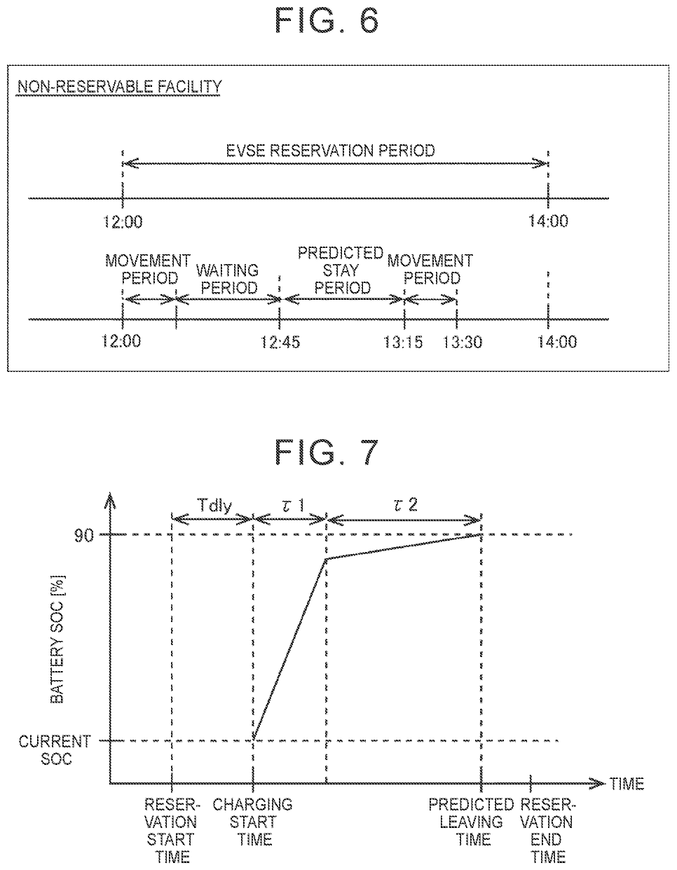

FIG. 6 shows an example in which a non-reservable facility 40 (e.g., the cafe 41) is extracted. The processor 101 extracts a facility 40 available within the reservation period for the EVSE unit 20 (12:00 to 14:00 in FIG. 6). Specifically, the processor 101 extracts a facility 40 in which a period from a start time of the reservation period for the EVSE unit 20 (12:00 in FIG. 6) to a time when the user returns to the EVSE unit 20 (13:30 in FIG. 6) is within the reservation period. The non-reservable facility 40 refers to a facility 40 with no reservation system.

The processor 101 predicts a use start time for the facility 40 (12:45 in FIG. 6) based on the start time of the reservation period for the EVSE unit 20, the movement period associated with step S7 (15 minutes in FIG. 6), and the waiting period associated with step S4 (30 minutes in FIG. 6). The processor 101 predicts a time when the user will leave the facility 40 (13:15 in FIG. 6) based on the use start time and the predicted stay period associated with step S6 (30 minutes in FIG. 6). The processor 101 predicts a time when the user will return to the EVSE unit 20 based on the movement period associated with step S7 and the predicted leaving time. That is, the processor 101 executes the extraction based on the total value of the predicted value of the stay period, the movement period, and the waiting period.

In step S9, the processor 101 displays the facilities 40 extracted in step S8 on the reservation screen 30. FIG. 4 shows an example in which the restaurant 42 and the cafe 41 are displayed on the reservation screen 30 as the reservable or available facilities 40.

The reservation screen 30 displays information on the incentives associated with the extracted facilities 40. In the example shown in FIG. 4, the reservation screen 30 displays a message 36 indicating that the restaurant 42 is discounted by 500 yen as the incentive in response to the selection of the restaurant 42.

The reservation screen 30 displays buttons 35 for determining the time to use the facility 40 (use start time). The buttons 35 associated with the restaurant 42 show the times when the restaurant 42 can be reserved. The button 35 associated with the cafe 41 shows a predicted time when the cafe 41 will be available.

In step S10, the user selects one of the buttons 35 displayed on the reservation screen 30 to determine the facility 40 to be used and the time to use it.

In step S11, the processor 101 determines whether the user has selected a reservation time frame for the facility 40 in step S10. Specifically, the processor 101 determines whether any button 35 associated with the reservable facility 40 (restaurant 42) has been selected. When any button 35 associated with the reservable facility 40 has been selected (Yes in S11), the process proceeds to step S12. When the button 35 associated with the non-reservable facility 40 (cafe 41) has been selected (No in S11), the process proceeds to step S13.

In step S12, the processor 101 executes a reservation process for the facility 40 and the time frame selected in step S10. In step S12, the reservation screen for the facility 40 may simply be displayed on the car navigation system 11 or the like, and the reservation process may be executed by the user himself/herself.

In step S13, the processor 101 executes a process for giving the incentive associated with the facility 40 selected in step S10 to the user.

In step S14, the processor 101 calculates charging execution conditions for causing the electrified vehicle 10 to have an SOC based on full charge (e.g., 90%) at the predicted leaving time associated with the facility 40 selected in step S10. The SOC based on full charge refers to an SOC close to full charge.

Specifically, as shown in FIG. 7, the execution conditions include information on a delay period Tdly from the reservation start time for the EVSE unit 20 to the start of charging. The execution conditions further include information on charging power in a period τ1 in which the battery 13 is charged with constant power. The execution conditions further include information on charging voltage in a period τ2 in which the battery 13 is charged with constant voltage.

In step S15, the processor 101 controls the electrified vehicle 10 so that the battery 13 is charged in accordance with the battery charging execution conditions calculated in step S14. The EVSE unit 20 may be controlled so that charging is executed in accordance with the execution conditions.

As described above, in the first embodiment, the server 100 includes the processor 101 that extracts, based on the reservation period reserved for the use of the EVSE unit 20 by the user of the electrified vehicle 10, the facility 40 that is available to the user during the reservation period, and the communication unit 103 that notifies the user about the information on the extracted facility 40. Thus, the user can easily determine a schedule for the reservation period by acquiring the information on the facility 40 that is available during the reservation period.

### Second Embodiment

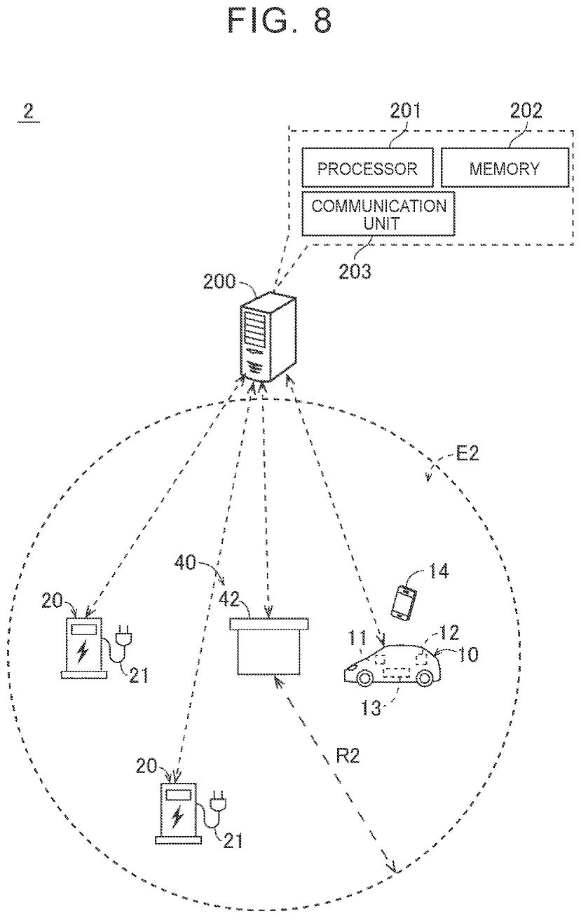

Next, a server 200 according to a second embodiment will be described with reference to FIGS. 8 to 13. In the second embodiment, EVSE units 20 that are available during a reservation period for a facility 40 are extracted unlike the first embodiment in which facilities 40 that are available during a reservation period for an EVSE unit 20 are extracted. The same components as those in the first embodiment are denoted by the same signs, and description thereof will not be repeated.

FIG. 8 shows the configuration of a system 2 according to the second embodiment. The system 2 includes a server 200, an electrified vehicle 10, a plurality of EVSE units 20, and a plurality of facilities 40. The system 2 may include one facility 40 alone. In the example shown in FIG. 2, the restaurant 42 is shown alone for simplification. The facility 40 may be the cafe 41. The restaurant 42 is an example of a “predetermined facility” according to the present disclosure.

The server 200 includes a processor 201, a memory 202, and a communication unit 203. The processor 201 is an example of the “control unit” according to the present disclosure.

The memory 202 stores, in addition to programs to be executed by the processor 201, information to be used in the programs (e.g., maps, mathematical formulas, and various parameters). The memory 202 stores position information of each EVSE unit 20 and position information of each facility 40. The memory 202 stores information on expected periods at the facilities 40.

The communication unit 203 includes various communication I/Fs. The processor 201 controls the communication unit 203. Specifically, the processor 201 communicates with the communication device 12 of the electrified vehicle 10 (or the mobile terminal 14), the EVSE units 20, and the facilities 40 via the communication unit 203.

In the second embodiment, the processor 201 extracts an EVSE unit 20 that is available, during an expected use period for the use of the facility 40, to the user who uses the facility 40 during the expected use period. The communication unit 203 transmits information on the extracted EVSE unit 20 to the electrified vehicle 10 associated with the user. The communication unit 203 may transmit the information to the mobile terminal 14 or to both the mobile terminal 14 and the electrified vehicle 10.

Facility Guidance Method

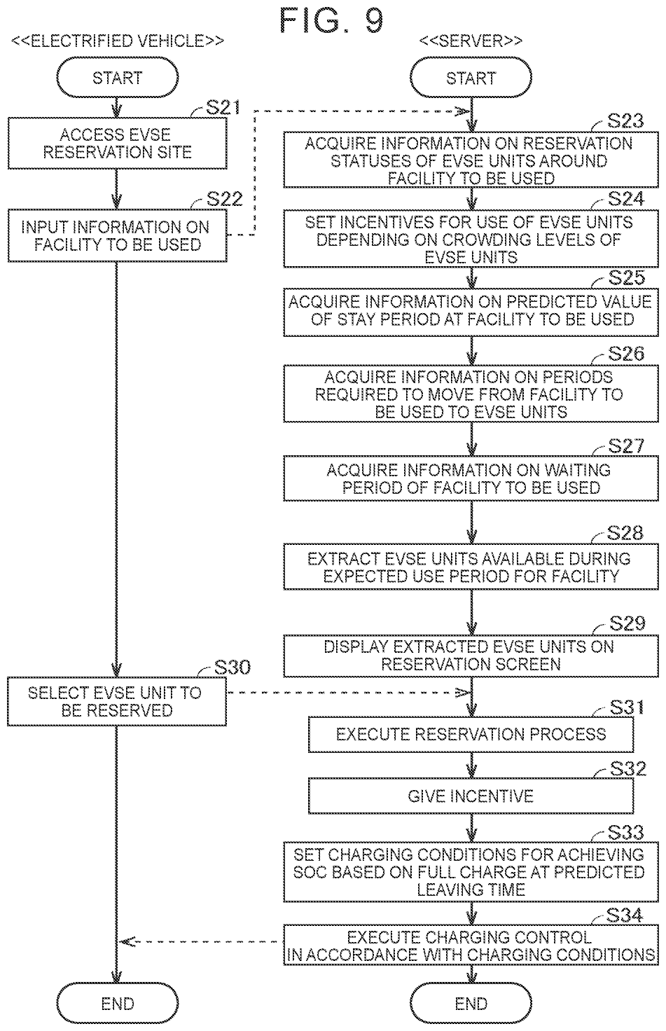

Referring to a sequence diagram of FIG. 9, description will be given of a method for giving guidance on the EVSE unit 20 to be used by the user during the reservation period for the facility 40 (restaurant 42).

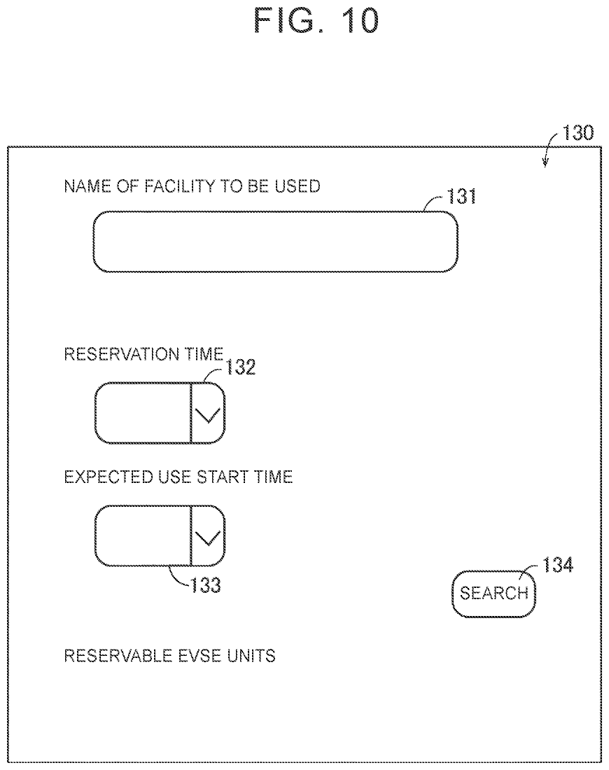

In step S21, the user of the electrified vehicle 10 accesses, through the navigation system 11, a reservation site for making a reservation to use the EVSE unit 20. A reservation screen 130 (see FIG. 10) for the EVSE unit 20 is displayed on the navigation system 11.

In step S22, the user of the electrified vehicle 10 inputs identification information of the facility 40 to be used in an input field 131 of the reservation screen 130. The user inputs a reservation time for a reservable facility 40 in an input field 132 of the reservation screen 130 or inputs an expected use start time for a non-reservable facility 40 in an input field 133. Since the reservable restaurant 42 is used in the second embodiment, the time is input in the input field 132. Each of the input field 132 and the input field 133 is a pull-down input field configured such that time can be selected with intervals of 15 minutes. When a button 134 of the reservation screen 130 is selected, processes of step S23 and subsequent steps are started. The facility 40 in the following description refers to the facility 40 to be used and input by the user in the input field 131.

In step S23, the processor 201 acquires information on reservation statuses or waiting periods of EVSE units 20 located within a predetermined range E2 (see FIG. 8) that is based on the position of the facility 40 specified in step S22. Thus, the processor 201 acquires information on crowding levels of the EVSE units 20 within the predetermined range E2. Examples of the predetermined range E2 include an area with a radius R2 (e.g., 500 m) about the facility 40. The EVSE units 20 in the following description refer to the EVSE units 20 located within the predetermined range E2. One EVSE unit 20 may be provided alone in the predetermined range E2.

In step S24, the processor 201 sets incentives for the use of the EVSE units 20. The processor 201 sets (adjusts) the incentives depending on the crowding levels of the EVSE units 20 based on the information acquired in step S23. Examples of the incentives include a discount on the usage fee of the EVSE unit 20. The processor 201 increases the incentive for an EVSE unit 20 having a lower crowding level.

In step S25, the processor 201 acquires information on a predicted value of a stay period at the facility 40. As described above, the predicted value of the stay period associated with the facility 40 is stored in the memory 202.

In step S26, the processor 201 acquires (calculates) information on periods required to move between the facility 40 and the EVSE units 20. Specifically, the processor 201 calculates distances between the EVSE units 20 and the facility 40 by using the position information of the EVSE units 20 and the position information of the facility 40 that are stored in the memory 202. The processor 201 calculates the periods required to move between the EVSE units 20 and the facility 40 based on the calculated distances.

In step S27, the processor 201 acquires information on a waiting period of the facility 40 to be used. Specifically, the processor 201 acquires the information on the waiting period through the communication unit 203.

In step S28, the processor 201 extracts EVSE units 20 reservable during the expected use period for the facility 40 based on the pieces of information associated with steps S23, S25, S26, and S27.

FIG. 12 shows an example in which a reservable facility 40 (e.g., the restaurant 42) is reserved. The processor 201 extracts an EVSE unit 20 in which the expected use period for the facility 40 (12:30 to 13:30 in FIG. 12) is within the reservation period (of the EVSE unit 20).

Specifically, when the reservation time for the facility 40 (restaurant 42) is 12:30, the processor 201 predicts that the use end time for the facility 40 is 13:30 based on the predicted stay period associated with the facility 40 (one hour in FIG. 12). The processor 201 calculates the minimum necessary reservation period for the EVSE unit 20 as 12:15 to 13:45 based on the expected use period for the facility 40 and the movement period associated with step S26 (15 minutes×2 in FIG. 12). The processor 201 extracts EVSE units 20 reservable at least in the period from 12:15 to 13:45.

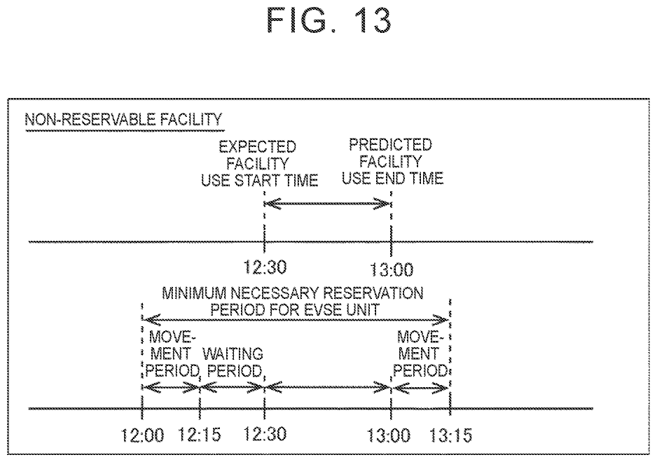

FIG. 13 shows an example in which the use of a non-reservable facility 40 (cafe 41) is expected. The processor 201 extracts an EVSE unit 20 in which the expected use period for the facility 40 (12:30 to 13:00 in FIG. 13) is within the reservation period (of the EVSE unit 20).

Specifically, when the expected use start time for the facility 40 (cafe 41) is 12:30, the processor 201 predicts that the use end time for the facility 40 is 13:00 based on the predicted stay period associated with the facility 40 (30 minutes in FIG. 13). The processor 201 calculates the minimum necessary reservation period for the EVSE unit 20 as 12:00 to 13:15 based on the expected use period for the facility 40, the movement period associated with step S26 (15 minutes×2 in FIG. 13), and the waiting period associated with step S27 (15 minutes in FIG. 13). The processor 201 extracts EVSE units 20 reservable at least in the period from 12:00 to 13:15.

If the EVSE units 20 have waiting periods, the extraction process of step S28 may be executed in consideration of the waiting periods.

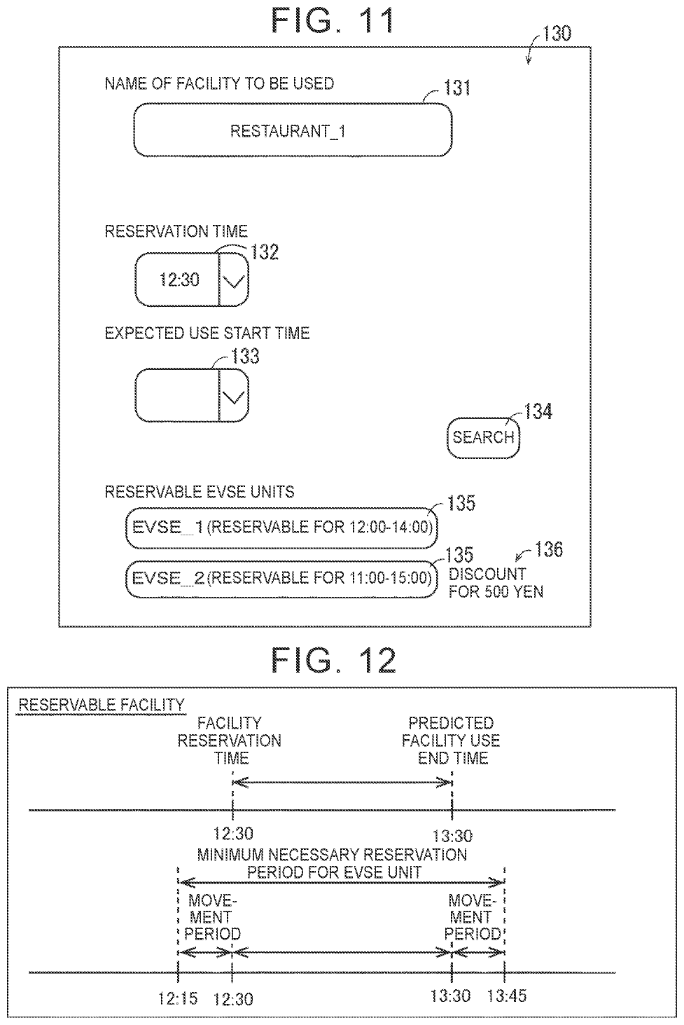

In step S29, the processor 201 displays the EVSE units 20 extracted in step S28 on the reservation screen 130 (see FIG. 11). The reservation screen 130 displays buttons 135 for determining the EVSE unit 20 to be used. The buttons 135 show identification information (numbers) of the EVSE units 20 and the reservable periods.

The reservation screen 130 displays a message 136 indicating the incentive associated with the extracted EVSE unit 20.

In step S30, the user selects one of the buttons 135 displayed on the reservation screen 130 to determine the EVSE unit 20 to be used.

In step S31, the processor 201 executes a reservation process for the EVSE unit 20 selected by the user in step S30. At this time, the EVSE unit 20 may be reserved in the minimum necessary reservation period for the EVSE unit 20 calculated by the processor 201. A screen (not shown) for inputting the reservation period for the EVSE unit 20 may be displayed on the car navigation system 11 or the like in response to the selection of the button 135.

In step S32, the processor 201 executes a process for giving the incentive associated with the EVSE unit 20 selected in step S30 to the user.

The processes of steps S33 and S34 are the same as the processes of steps S14 and S15 of the first embodiment, respectively, and therefore description thereof will not be repeated.

The other configurations of the second embodiment are the same as those of the first embodiment, and therefore description thereof will not be repeated.

The first and second embodiments illustrate the example in which charging is executed by the EVSE unit 20, but the present disclosure is not limited to this. Discharging (discharging related to a virtual power plant (VPP) or energy management) may be executed by the EVSE unit 20. Both charging and discharging may be executed by the EVSE unit 20. The first and second embodiments illustrate the example in which the expected use period for the facility 40 is within the reservation period for the EVSE unit 20, but the present disclosure is not limited to this. A part of the expected use period for the facility 40 may be outside the reservation period for the EVSE unit 20.

The first and second embodiments illustrate the example in which the facility 40 or the EVSE unit 20 is extracted based on the reserved stay period, the waiting period, and the movement period for the facility 40, but the present disclosure is not limited to this. The extraction may be executed without using the information on any of the reserved stay period, the waiting period, and the movement period. The extraction may be executed by using the information on any one of the reserved stay period, the waiting period, and the movement period. The extraction may be executed by using the information on any two of the reserved stay period, the waiting period, and the movement period.

The first embodiment illustrates the example in which the user specifies the type of facility 40 desired by the user, but the present disclosure is not limited to this. The server 100 may predict the type of facility 40 desired by the user based on a time frame, a user's action history, and the like. The facility 40 may be extracted without using the information on the type of facility 40 desired by the user.

The first and second embodiments illustrate the example in which the extraction target is the facility 40 (EVSE unit 20) located in the predetermined range E1 (E2) about the EVSE unit 20 (facility 40), but the present disclosure is not limited to this. The extraction target range need not be limited.

The first and second embodiments illustrate the example in which the incentive is given depending on the crowding level of the facility 40 or the EVSE unit 20 that the user determines to use, but the present disclosure is not limited to this. The incentive may be fixed regardless of the crowding level. No incentive may be given to the user regardless of the use of the facility 40 or the EVSE unit 20.

The first and second embodiments illustrate the example in which charging is executed so that the SOC of the electrified vehicle 10 reaches the value based on full charge (90%) at the expected leaving time for the facility 40, but the present disclosure is not limited to this. The charging execution conditions (charging power and charging start time) may be fixed regardless of the expected leaving time. Charging may be executed so that the SOC of the electrified vehicle 10 reaches a full charge SOC (100%) at the expected leaving time for the facility 40.

The first and second embodiments illustrate the example in which the user is notified about the extraction result by displaying the extracted facility 40 or the extracted EVSE unit 20 on the reservation screen 30 (130), but the present disclosure is not limited to this. For example, the user may be notified about the extraction result by voice.

The configurations (processes) of the embodiments and the modifications may be combined with each other.

The embodiments disclosed herein should be considered to be illustrative in all respects and not restrictive. The scope of the present disclosure is shown by the claims rather than by the above description of the embodiments, and is intended to include all modifications within the meaning and scope equivalent to the claims.

What is claimed is:

1. A server comprising:
a control unit configured to extract, among facilities different from a power controller configured to execute power control including at least one of charging and discharging of an electrified vehicle, the facility that is available, during a reservation period for use of the power controller, to a user who uses the power controller during the reservation period; and
a communication unit configured to transmit information on the extracted facility to at least one of the electrified vehicle and an information device that are associated with the user.

2. The server according to claim 1, wherein the control unit is configured to extract the facility that is reservable within the reservation period.

3. The server according to claim 1, wherein the control unit is configured to extract the facility that is available during the reservation period based on a predicted value of a stay period at the facility.

4. The server according to claim 1, wherein the control unit is configured to extract the facility that is available during the reservation period based on a waiting period for use of the facility.

5. The server according to claim 1, wherein the control unit is configured to extract the facility that is available during the reservation period based on a movement period required to move from the power controller to the facility.

6. The server according to claim 1, wherein the control unit is configured to extract the facility that is available during the reservation period based on a total value of a predicted value of a stay period at the facility, a waiting period for use of the facility, and a movement period required to move from the power controller to the facility.

7. The server according to claim 1, wherein the control unit is configured to extract the facility that is available during the reservation period based on a type of the facility that the user desires to use during the reservation period.

8. The server according to claim 1, wherein the control unit is configured to extract the facility located within a predetermined range that is based on a position of a reserved power controller.

9. The server according to claim 1, wherein the control unit is configured to adjust an incentive to be given to the user depending on a crowding level of the facility that the user determines to use during the reservation period.

10. The server according to claim 3, wherein the control unit is configured to
predict a time when the user leaves the facility based on the predicted value of the stay period,
calculate an execution condition of the power control for causing the electrified vehicle to have a state of charge based on full charge at the leaving time associated with the facility that the user determines to use, and
control the electrified vehicle to execute the power control in accordance with the execution condition.

11. A guidance method comprising:
a step of extracting, among facilities different from a power controller configured to execute power control including at least one of charging and discharging of an electrified vehicle, the facility that is available, during a reservation period for use of the power controller, to a user who uses the power controller during the reservation period; and
a step of transmitting information on the extracted facility to at least one of the electrified vehicle and an information device that are associated with the user.

12. A server comprising:
a control unit configured to extract, among power controllers each configured to execute power control including at least one of charging and discharging of an electrified vehicle, the power controller that is available, during an expected use period for use of a facility different from the power controllers, to a user who uses the facility during the expected use period; and
a communication unit configured to transmit information on the extracted power controller to at least one of the electrified vehicle and an information device that are associated with the user.

13. The server according to claim 1, further comprising a storage unit configured to store information on a plurality of the users, wherein the control unit includes a processor.

14. The guidance method according to claim 11, further comprising a step of notifying the user about information on the power controller that has been transmitted to at least one of the electrified vehicle and the information device that are associated with the user.
